(19) United States
(12) Patent Application Publication
(10) Pub. No.: US 2024/0316870 A1
(43) Pub. Date: Sep. 26, 2024

(54) CONTROL OF WITHDRAWAL MOVEMENT IN 3D PRINTING USING A NEURAL NETWORK

(71) Applicants: DENTSPLY SIRONA Inc., York, PA (US); SIRONA DENTAL SYSTEMS GMBH, Bensheim (DE)

(72) Inventor: Christian STAHL, Darmstadt (DE)

(73) Assignee: DENTSPLY SIRONA Inc., York, PA (US)

(21) Appl. No.: 18/578,452

(22) PCT Filed: Jul. 12, 2022
(86) PCT No.: PCT/EP2022/069383

§ 371 Date: Jan. 11, 2024

(30) Foreign Application Priority Data
Jul. 12, 2021 (EP) 21184958.3

(51) Int. Cl. B29C 64/393; B29C 64/124; B29C 64/245; B29C 64/255; B33Y 10/00; B33Y 30/00; B33Y 50/02

(52) U.S. Cl. CPC B29C 64/393; B29C 64/124; B29C 64/245; B29C 64/255; B33Y 10/00; B33Y 30/00; B33Y 50/02

(57) ABSTRACT

Aspects relates to a 3D printer including a vat having an at least partially transparent bottom for receiving liquid photoreactive resin to produce a solid component; a building platform for holding and pulling out the component layer by layer from the vat; a projector for projecting the layer geometry onto the transparent bottom; a transport apparatus for at least downward and upward movement of the building platform in the tray; and a control device for controlling the projector and the transport apparatus. The control device optimally feed forward controls the pull-off movement of the build platform in the 3D printer using a neural network.

The entire content of the priority application EP21184958.3 is hereby incorporated by reference to this international application under the provisions of the PCT.

### TECHNICAL FIELD OF THE INVENTION

The present invention relates to additive manufacturing processes, in particular 3D printing processes and 3D printers.

### BACKGROUND OF THE INVENTION

In 3D printing, certain processes such as SLA or DLP create a component by curing photoreactive resin layer by layer. In common variants of the processes, the exposure is carried out from below through a transparent bottom into a vat. The solidified layer usually has to be mechanically separated from the bottom after exposure. The forces that occur during this process depend, among other things, on the exact configuration of the pull-off movement (direction, speed, etc.). On the one hand, these forces must be kept as low as possible to avoid damage to the component; on the other hand, too careful detachment means unnecessarily slow printing. If the time at which the component is detached cannot be detected, then unnecessary travel is always required to ensure detachment, which makes the process even slower.

In known systems based purely on feed forward control of the pull-off movement, a conservative pull-off movement based on empirical values must be selected. Depending on the complexity of the underlying model, the pull-off movement is more or less unnecessarily slow. In systems where the pull-off movement is actively controlled (i.e., current force signal determines the pull-off speed and detects the time of detachment of the component), an approximately maximum speed for a set force maximum and an optimum pull-off height can always be run. However, for the active control of the pull-off movement, a sensor system and a corresponding control unit in the machine are required, which uses the sensor data.

### DISCLOSURE OF THE INVENTION

The objective of the present invention is to provide a 3D printing system with which an optimized peel-off process can be calculated, which can be used for feed forward controlling the pull-off motion to optimize, for example, the printing time while protecting the component, without requiring the 3D printer to have a sensor system and a control unit suitable for active control.

This objective is achieved by the 3D printer according to claim 1, and the neural network according to claim 8. The subject-matters of the dependent claims relate to further developments as well as preferred embodiments.

The 3D printer according to the invention comprises a vat having an at least partially transparent bottom for receiving liquid photoreactive resin for producing a solid component; a building platform for holding and pulling the component out of the vat layer by layer; a projector for projecting the layer geometries onto the transparent bottom; a transport apparatus for at least downward and upward movement of the building platform in the vat; and a control device for controlling the projector and the transport apparatus, wherein the control of the pull-off movement of the building platform in the 3D printer is performed by means of optimized feed forward control data determined by a neural network without using sensory (force) measurement data of the pull-off movement from the current production process.

The neural network according to the present invention is used to generate data for controlling the 3D printer. The neural network may be implemented by hardware and/or software. The neural network may be provided integrated with the 3D printer. Alternatively, the neural network may be provided separately in a system external to the 3D printer. The 3D printer can be connected to the neural network locally or via a network.

A major advantageous feature of the present invention is that the neural network according to the invention is, on the one hand, an alternative to active control and, on the other hand, offers the advantage over the active control that no sensor and control components required for active control of the pull-off movement need to be provided with or installed in the 3D printing system to which the invention is applied. The optimization of the pull-off movement according to the invention includes further optimization modes in addition to “maximum speed at given maximum force”, such as minimum force at given maximum movement time.

The neural network can preferably calculate the degree of adhesion of the component based on the properties of the liquid photoreactive resin and/or the area solidified in the respective exposed layer and/or the energy distribution introduced in the area to be solidified, and feed forward control the pull-off movement of the building platform in 3D printing accordingly.

The neural network can preferably calculate a force profile for the degree of adhesion, where the force is specified as a function of the travelled stroke and/or time, and feed forward control the pull-off movement of the building platform in 3D printing accordingly.

The neural network can preferably take into account further degrees of freedom such as an additional axis of motion (horizontal movement of the building platform in the 3D printer) e.g., for the degree of adhesion or the force profile. Thus, the pull-off direction can be optimized.

In another preferred embodiment, auxiliary structures on the building platform that are not part of the component can be determined with respect to optimal pull-off movement and pull-off direction.

In another preferred embodiment, the layers of the component are divided into multiple exposures for optimal control of the peel force and pull-off movement.

The neural network is trained with data including the time of detachment of a component and (maximum) forces occurring in that layer during detachment, as well as at least one of the following characteristics:
Properties of the liquid photoreactive resin
area solidified (cured) in the respective exposed layer
energy distribution introduced into the area to be solidified (cured)
   in order to train the neural network for predicting the forces and detachment times encountered with this photoreactive resin, so that the output of the neural network can be used to optimize the pull-off movement of the building platform. Different optimization criteria (see above) can be used.

The neural network can be trained in advance with a 3D printer (“laboratory machine”), which can perform force measurements using force sensors. One or more force sensors can be placed in the transport apparatus and/or on the building platform to measure the horizontal and/or vertical forces acting thereon, e.g., during the pull-off movement.

The trained neural network can be used to control a 3D printer (“field machine”) that does not necessarily have a force measurement device, such as force sensors. The field machine can also be equipped with force measurement devices so that, among other things, training data can be collected by the customer. The training data can be made available via a cloud for training the neural network. Force measurement devices can optionally also be used on the field machine for securing the 3D print job.

An advantageous effect of the invention is that the neural network can be trained to the optimal pull-off movement for a specific 3D printer and/or a specific 3D printing job. Thus, the operation of the 3D printer as well as a specific 3D printing job can be performed optimally in terms of speed and/or safety.

### BRIEF DESCRIPTION OF THE DRAWING

In the following description, the present invention will be explained in more detail by means of exemplary embodiments with reference to the drawing, whereby

FIG. 1—shows a schematic partial view of a 3D printer according to one embodiment of the invention.

The reference numbers shown in the drawing designate the elements listed below, which are referred to in the following description of the exemplary embodiments.

| | |
|---|---|
| 1 | 3D Printer |
| 1.1 | Vat |
| 1.2 | Transparent bottom |
| 1.3 | Photoreactive resin |
| 1.4 | Projector |
| 1.5 | Transport apparatus |
| 1.6 | Foil |
| 1.7 | Layer |
| 1.8 | Building platform |

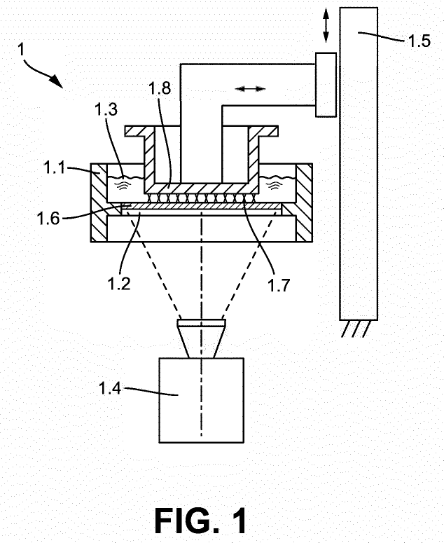

As shown in FIG. 1 shown, the 3D printer (1) comprises a vat (1.1) having an at least partially transparent bottom (1.2) for receiving liquid photoreactive resin (1.3) to produce a solid component; a building platform (1.8) for holding and pulling the component layerwise out of the vat (1.1); a projector (1.4) for projecting the layer geometry onto the transparent bottom (1.2); a transport apparatus (1.5) for moving the build platform (1.8) at least downward and upward in the vat (1.1); and a control device for controlling the projector (1.4) and the transport apparatus (1.5). The pull-off movement of the building platform in the 3D printer is optimally feed forward controlled by the control device by using a neural network (not shown).

In a preferred embodiment, the neural network determines the degree of adhesion of the component by at least one of the following characteristics: (i) properties of the liquid photoreactive resin (1.3), (ii) the area solidified in the respective exposed layer (1.7), (iii) the energy distribution introduced in the area to be solidified. The pull-off motion of the build platform in 3D printing is feed forward controlled by the control device using the neural network based on the determined degree of adhesion. By using the information in (i) to (ii), the pull-off movement can be effectively performed according to the material used and the current step of the printing process. The nature (composition) or type of the liquid photoreactive resin (1.3) used by the 3D printer can already be stored in a memory in a retrievable manner. Because the use of different photoreactive resins (1.3) is also conceivable, the information about the nature or type of the liquid photoreactive resin (1.3) currently being used can also preferably be entered via a user interface (not shown) by the users o that the neural network can take into account the material currently being used. The user interface is preferably located on the 3D printer (1). Alternatively, it may be present in a separate device (e.g., computer, tablet, etc.) that is in communication with the neural network and/or the 3D printer.

In a further preferred embodiment, the neural network calculates a force profile in accordance with the degree of adhesion. The force is specified as a function of the stroke traveled and/or the respective time. The pull-off movement of the building platform in the 3D printing is additionally feed forward controlled by the control device by means of the neural network on the basis of the calculated force profile. By using the force profile, the pull-off movement can be performed effectively.

The transport apparatus (1.5) has at least one vertical axis of movement for the downward and upward movement of the building platform (1.2) in the vat (1.1). In a further preferred embodiment, the transport apparatus (1.5) preferably also has a horizontal axis of movement for the sideways movement of the building platform (1.2) in the vat (1.3). The motion axes each comprise a separate motor and a threaded rod coupled to the building platform (1.3). In addition to the movement of the building platform (1.2) in the vertical axis of motion, the neural network also considers the movement in the horizontal axis of motion.

### Training Data and Training the Neural Network

The training data are generated with a 3D printer (laboratory machine), which additionally has a force measuring device for recording the time of detachment of the component and forces occurring in that layer during such detachment. The acquired data in combination with at least one of the following characteristics: (i) properties of the liquid photoreactive resin (1.3), (ii) the area solidified in the respective exposed layer (1.7) (iii) the energy distribution introduced in the area to be solidified are made available for training the neural network. The neural network is trained using this data. The training preferably takes place in connection with a laboratory machine.

### Use of the Neural Network

The output of the trained neural network can be used to control a 3D printer (1) (field machine) that does not have a force measurement device or any equivalent means. The neural network can be trained in advance with sensory data from the above laboratory machine. The field machine can also be optionally equipped with a force measuring device for safety reasons, which measures the occurring forces and/or also collects training data. In an alternative preferred embodiment, the neural network is implemented as hardware and/or software. The software features computer-readable code that can be executed by a computer-based 3D printer. The computing unit may be integrated into the 3D printer or provided as a separate computer that is connectable to the 3D printer. The software may be provided in a storage medium in conjunction with the 3D printer.

1. A 3D printer comprising:
a vat having an at least partially transparent bottom for receiving liquid photoreactive resin for producing a solid component;
a building platform for pulling the solid component out of the vat layer by layer;
a projector for projecting the layer geometry onto the transparent bottom; a transport apparatus for moving the building platform at least downward and upward in the vat; and
a control device for controlling the projector and the transport apparatus,
wherein the control device optimally feed forward controls the pull-off movement of the building platform in the 3D printer using a neural network.

2. The 3D printer according to claim 1, wherein the neural network determines the degree of adhesion of the solid component by at least one of the following characteristic values:
(i) properties of the liquid photoreactive resin as material,
(ii) an area solidified in the respective exposed layer,
(iii) an energy distribution introduced in the area to be solidified,
wherein the control device feed forward controls the pull-off movement of the building platform in the 3D printer using the neural network on the basis of the determined degree of adhesion.

3. 3D printer according to claim 2, wherein the neural network calculates a force profile in accordance with the degree of adhesion, wherein the force is specified as a function of the travelled stroke and/or the time, and wherein the control device additionally feed forward controls the pull-off movement of the building platform in the 3D printing using the neural network on the basis of the calculated force profile.

4. 3D printer according to one of the preceding claim 2, wherein the neural network, in addition to a movement of the building platform in a vertical axis, also takes into account another movement in the horizontal axis.

5. 3D printer according to claim 1, further comprising: a user interface for inputting information about the nature or type of liquid photoreactive resin currently being used.

6. 3D printer according to claim 1, wherein the neural network has been trained with data describing a time of detachment of a component and forces occurring in a layer during detachment, as well as at least one of the following characteristic values: (i) properties of the liquid photoreactive resin as material, (ii) an area solidified in the respective exposed layer, (iii) an energy distribution introduced in the area to be solidified, in order to enable the neural network to predict the forces and detachment times that will occur with this material, so that the output of the neural network can be used to optimize the pull-off movement.

7. 3D printer according to claim 1, wherein the 3D printer has a force measuring device for detection of data of the time of detachment of the solid component and the forces occurring during detachment, wherein the data of said in combination with at least one of the following characteristic values: (i) properties of the liquid photoreactive resin as material, (ii) the area solidified in the respective exposed layer, (iii) the energy distribution introduced into the area to be solidified, are made available by the force measuring device for training the neural network, and the neural network trains itself or is trained further on the basis of these data.

8. A neural network for controlling a 3D printer that comprises:
a vat having an at least partially transparent bottom for receiving liquid photoreactive resin for producing a solid component;
a building platform for holding and pulling out the solid component layer by layer from the vat;
a projector for projecting the layer geometry onto the transparent bottom; a transport apparatus for at least moving the building platform downward and upward in the vat; and
a control device for controlling the projector and the transport apparatus characterized in that
by means of the neural network via the control device, the pull-off movement of the building platform in 3D printing is optimally feed forward controlled,
wherein the neural network determines a degree of adhesion of the solid component to the transparent bottom by at least one of the following characteristic values: (i) properties of the liquid photoreactive resin as material, (ii) an area solidified in the respective exposed layer, (iii) an energy distribution introduced into the area to be solidified, wherein by means of the neural network via the control device, the pull-off movement of the building platform in the 3D printer is feed forward controlled on the basis of the determined degree of adhesion.

9. (canceled)

10. Neural network according to claim 8, wherein the neural network calculates a force profile in accordance with the degree of adhesion, wherein the force is specified as a function of the travelled stroke and/or the time, and wherein by using the neural network via the control device the pull-off movement of the build platform in the 3D printing is feed forward controlled on the basis of the calculated force profile.

11. Neural network according to claim 8, wherein the neural network, in addition to a movement of the building platform in a vertical axis, also takes into account another movement in a horizontal axis.

12. Neural network according to claim 8, wherein the 3D printer comprises a user interface for inputting information about a nature or type of liquid photoreactive resin currently being used, wherein the neural network takes this input into account.

13. The neural network according to claim 8, wherein the 3D printer has a force measuring device for detection of data of a time of detachment of the solid component and forces occurring in a layer during detachment, wherein the data in combination with at least one of the following characteristic values: (i) properties of the liquid photoreactive resin as material, (ii) an area solidified in the respective exposed layer, (iii) an energy distribution introduced into the area to be solidified are made available by the force measuring device for training the neural network, characterized in that the neural network is trained on the basis of these data.

14. (canceled)

15. (canceled)
